(19) United States
(12) Patent Application Publication
(10) Pub. No.: US 2015/0136693 A1
(43) Pub. Date: May 21, 2015

(54) CYTOKINE ADSORPTION SHEET, METHOD FOR MANUFACTURING THE SAME, AND BLOOD FILTER COMPRISING THE SAME

(71) Applicants: AMOGREENTECH CO., LTD., Gimpo-si (KR); SNU R&DB FOUNDATION, Seoul (KR)

(72) Inventors: Jun Sik HWANG, Incheon (KR); Sang Chul SUH, Seoul (KR); Chan KIM, Gwangju-si (KR); Seung Hoon LEE, Paju-si (KR); Hee Chan KIM, Seoul (KR); Jung Chan LEE, Seoul (KR); Gil Joon SUH, Seoul (KR); Woon Yong KWON, Seoul (KR); Kyung Su KIM, Seoul (KR)

(21) Appl. No.: 14/584,137

(22) Filed: Dec. 29, 2014

Related U.S. Application Data
(62) Division of application No. PCT/KR2013/005710, filed on Jun. 27, 2013.

(30) Foreign Application Priority Data
Jun. 29, 2012 (KR) 10-2012-0071276

(51) Int. Cl. D04H 1/407; B32B 38/00; B01D 39/16

(52) U.S. Cl. CPC D04H 1/407; B01D 39/163; B32B 38/0032; D10B 2509/026
USPC 210/502.1; 442/414; 442/351; 428/220; 442/381; 442/370; 442/268; 442/1; 442/378; 264/413; 156/150

(57) ABSTRACT

A cytokine adsorption sheet comprises a nanofiber web formed by electrospinning a spinning solution prepared by mixing an adsorbent material capable of adsorbing cytokine and an electrospinnable polymer material. Thus, the dissolution of the adsorbent material by blood can be prevented.

### CROSS REFERENCE TO RELATED APPLICATIONS

This application is a divisional application of International Application No. PCI/KR2013/005710 filed on Jun. 27, 2013, which claims priority to and the benefit of Korean Application No. 10-2012-0071276 filed on Jun. 29, 2012, in the Korean Patent Office, the entire contents of which are incorporated herein by reference.

### TECHNICAL FIELD

The present invention relates to a cytokine adsorption sheet that can effectively adsorb and remove pro-inflammatory cytokines from blood to thereby treat sepsis, a method for manufacturing the same, and a blood filter comprising the same.

### BACKGROUND ART

Sepsis is known as a disease that is caused by the breakdown of the immune response system in vivo due to cytokines that are overproduced to defend against toxins released from bacteria, viruses, parasites or fungi.

Sepsis shows complex and diverse clinical manifestations, because pathogenic microbial infection affects various functional systems including the immune system, clotting system and neurohormonal system of a host, and exhibits systemic responses related thereto. If the clinical manifestations are severe, multiple organ dysfunction syndrome occurs, leading to death Thus, sepsis is a major cause of death in intensive care units, and still has a mortality of more than 20%.

Current methods that are used to treat sepsis include early antibiotic administration, fluid therapy, and early goal directed therapy based on administration of a vasopressor. However, an effective therapeutic method based on the regulation of immune functions, which shows excellent results, has not yet been reported.

In addition, studies on blood filters for adsorbing and removing pro-inflammatory cytokines reported methods of coating polymyxin-B (EP 424698, Therapeutic Apheresis and Dialysis (2003) 7(1): 108), Toraymyxin, polyethyleneimine (PEI) (Artificial Organs (1993) 17(9): 775, Artificial Organs (1996)), polyvinylpyrrolidone (PVP) (Critical Care Medicine (2004) 32(3): 801) or the like on granular activated carbon (Biomaterials (2006) 27:5286, 5755), Adsorba, beads, fibrous substrates or the like.

If such adsorbent materials are coated on substrates, the coated adsorbent materials can be dissolved by blood, and if they are released in vivo, they show strong renal toxicity or cytotoxicity. In addition, the clinical effects of the adsorbent materials have not yet been clearly demonstrated.

Moreover, beads or substrates that are used for the adsorbent materials cannot provide a sufficient area for contact with blood due to their limited specific surface area. In addition, activated carbon cannot also provide a sufficient surface area, because the pores thereof are clogged by the coated adsorbent materials.

In the prior art, Korean Patent No. 10-1151139 (May 22, 2012) discloses a blood filter for removing leukocytes, toxins, proteins or the like from blood by filtration or adsorption, which comprises a nanofiber dispersion consisting of polyester or polyamide staple, in which the content of staple fibers having a number average diameter of 1-500 nm and a diameter ranging from 500 nm to 1 μm is 3% by weight or less.

However, the blood filter according to the prior art has a problem in that, because it is made of polyester or polyamide so that blood components are filtered or adsorbed by the pores of the nanofibers, it cannot adsorb special components such as pro-inflammatory cytokines.

In addition, if blood filters according to the prior art are to be used to adsorb special components such as pro-inflammatory cytokines, an adsorbent material is coated on the filter surface. In this case, as described above, there is a problem in that the adsorbent material coated on the filter surface can be dissolved by blood.

### DISCLOSURE

### Technical Problem

The present invention has been made in order to solve the above-described problems occurring in the prior art, and it is an object of the present invention to provide a cytokine adsorption sheet and a manufacturing method thereof, in which the cytokine adsorption sheet comprises a nanofiber web formed by an electrospinning method, and thus has an increased area for contact with cytokines and an increased capacity to adsorb cytokines.

Another object of the present invention is to provide a cytokine adsorption sheet and a manufacturing method thereof, in which the cytokine adsorption sheet comprises a nano fiber web formed by an electrospinning method, and thus the thickness of the sheet can be freely controlled, and the sheet can be made thin so that a blood filter comprising the sheet can be miniaturized while having an increased capacity to adsorb cytokines.

Still another object of the present invention is to provide a cytokine adsorption sheet and a manufacturing method thereof, in which the cytokine adsorption sheet is manufactured using a mixture of a cytokine adsorbent material and an electrospinnable polymer material by an electrospinning method, and the dissolution of the adsorbent material by blood can be minimized.

Yet another object of the present invention is to provide a blood filter comprising a nanofiber web-type cytokine adsorption sheet capable of effectively adsorbing and removing cytokines.

The objects of the present invention are not limited to the above-mentioned objects, and other objects of the present invention will be clearly understood by those skilled in the art from the following description of a nanofiber web.

### Technical Solution

In order to accomplish the above objects, the present invention provides a cytokine adsorption sheet comprising a nanofiber web formed by electrospinning a spinning solution obtained by mixing an adsorbent material capable of adsorbing cytokines with an electrospinning polymer material.

The nano fiber web according to the present invention is formed to have a plurality of pores by stacking of nanofibers formed by electrospinning of the spinning solution, and has a nanofiber diameter of 100-800 nm and an average pore size of 0.1-10 μm.

The adsorbent material that is used in the present invention is any one or a mixture of two or more selected from among polymyxin-B, PEI, PVP, and PS-DVB (polystyrene-divinylbenzene).

The polymer material that is used in the present invention is one or a mixture of two or more selected from among PVdF (polyvinylidene fluoride), PMMA (polymethylmethacrylate), PAN (polyacrylonitrile), PU (polyurethane), PES (polyethersulfone), PAA (polyamic acid), PVA (polyvinyl alcohol), PEO (polyethylene oxide), PLA (polylactic acid), PGA (polyglycolic acid), and PLA-PGA-based polymers.

The cytokine adsorption sheet according to the present invention further comprises a base sheet laminated on one surface of the nanofiber web, and the base sheet has a plurality of pores permeable to blood, and is made of any one or a combination of two or more selected from a nonwoven fabric, a woven fabric, a polymer or metal foam material, paper, and a metal or plastic mesh material.

A blood filter according to the present invention comprises a cytokine adsorption sheet rolled around itself at a predetermined interval so as to have a passage through which blood passes, and a spacer is disposed in the passage.

A method for manufacturing a cytokine adsorption sheet according to the present invention comprises the steps of: dissolving an adsorbent material capable of adsorbing cytokines with an electrospinnable polymer material in a solvent to prepare a spinning solution; and forming a nanofiber web having a plurality of pores by electrospinning the spinning solution.

The step of forming the nanofiber web is performed by applying a high-voltage electrostatic force between a collector and a spinning nozzle, spinning nanofibers from the spinning nozzle onto the collector, and stacking the nanofibers on the collector.

The method for manufacturing a cytokine adsorption sheet according to the present invention further comprises the steps of: passing the nanofiber web through pressing rolls to press it to a predetermined thickness; and laminating a base sheet on one surface of the nanofiber web.

The base sheet is attached to one surface of the nanofiber web by any one method selected from hot melting, calendering, laminating, hot-melt bonding, and bonding.

### Advantageous Effects

As described above, the cytokine adsorption sheet according to the present invention comprises a nanofiber web formed by an electrospinning method, and thus can have an increased area for contact with cytokines and an increased capacity to adsorb cytokines.

Furthermore, the cytokine adsorption sheet according to the present invention comprises a nanofiber web formed by an electrospinning method, and thus the thickness of the sheet can be freely controlled, and the sheet can be made thin so that a blood filter comprising the sheet can be miniaturized while having an increased capacity to adsorb cytokines.

In addition, the cytokine adsorption sheet is manufactured using a mixture of a cytokine adsorbent material and an electrospinnable polymer material by an electrospinning method, and the dissolution of the adsorbent material by blood can be minimized.

### DESCRIPTION OF DRAWINGS

FIG. 1 is an enlarged photograph of a cytokine adsorption sheet manufactured according to an embodiment of the present invention.

FIG. 2 shows the configuration of an electrospinning apparatus for manufacturing a cytokine adsorption sheet according to an embodiment of the present invention.

FIG. 3 shows the configuration of an electrospinning apparatus according to another embodiment of the present invention.

FIG. 4 is a cross-sectional view of a blood filter according to an embodiment of the present invention.

FIG. 5 is a cross-sectional view of a cytokine adsorption sheet that is included in a blood filter according to an embodiment of the present invention.

FIG. 6 is an enlarged photograph of a cytokine adsorption sheet manufactured in Example 3 of the present invention.

FIG. 7 is an enlarged photograph of a cytokine adsorption sheet manufactured in Example 4 of the present invention.

### MODE FOR INVENTION

Hereinafter, the present invention will be described in further detail with reference to the accompanying drawings. The size or shape of the components shown in the drawings may be exaggerated for the clarity and convenience of explanation. In addition, the terms of constituent elements, which will be described hereinafter, are defined in consideration of their functions in the present invention and may be changed according to the intention of a user or an operator, or according to the custom. Accordingly, definitions of these terms should be based on the disclosure through the specification.

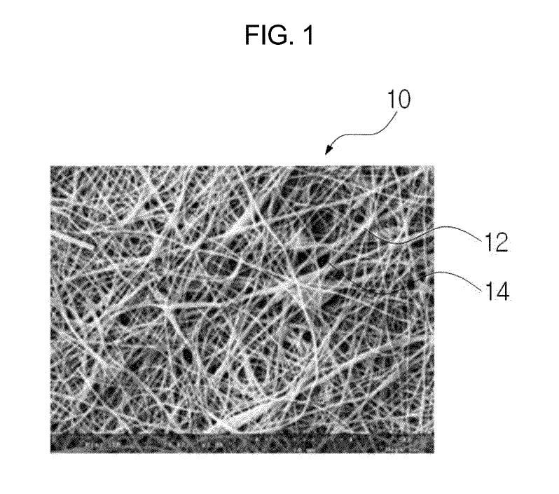

FIG. 1 is an enlarged photograph of a cytokine adsorption sheet manufactured according to an embodiment of the present invention. The cytokine adsorption sheet comprises a nanofiber web 10 prepared by electrospinning a spinning solution prepared by mixing an adsorbent material capable of cytokines with an electrospinnable polymer material, in which the nanofiber web 10 has a nanofiber diameter of less than 1 μm and includes a plurality of pores.

This cytokine adsorption sheet is manufactured by mixing an electrospinnable polymer material and an adsorbent material capable of adsorbing cytokines, to make a spinning solution having an electrospinnable viscosity, electrospinning the spinning solution to make nanofibers 12, and stacking the nanofibers 12 to form a nanofiber web 10 having a plurality of pores 14.

The nanofibers 12 have a diameter of about 100-800 nm, and the pores 14 have an average pore size of 0.1-10 μm. Herein, the pores 14 are preferably formed to have an average pore size of 0.5 μm, because the capacity to adsorb cytokines is closely associated with the specific surface area of the adsorption sheet and the time of contact with blood.

Further, the cytokine adsorption sheet has a thickness ranging from 1-150 μm, and is most preferably formed to have a thickness of 15-20 μm in view of the minimum strength and contact area of a blood filter manufactured the same.

The content of the polymer material and the adsorbent material is 5-90 wt % based on the total weight of the spinning solution, and is most preferably 10-30 wt % in view of the stability of spinning the strength of the nanofibers 12 and the size of the pores 14.

Herein, the absorbent material capable of adsorbing cytokines is any one or a mixture of two or more selected from polymyxin-B, PEI, PVP, and PS-DVB (polystyrene-divinylbenzene). In addition, any material, which can adsorb cytokines while dissolving in a solvent, may be used.

Among such materials capable of adsorbing cytokines, a material capable of being formed into a nanofiber web by electrospinning may be electrospun alone, but is preferably electrospun in combination with a medical polymer material in order to improve the physical properties of the adsorption sheet.

Further, the polymer material that is used in the present invention may be a material is electrospinnable and, at the same time, can be used for medical applications. For example, the polymer material that is used in the present invention may be one or a mixture of two or more selected from PVdF (polyvinylidene fluoride), PMMA (polymethylmethacrylate), PAN (polyacrylonitrile), PU (polyurethane), PES (polyethersulfone), PAA (polyamic acid), PVA (polyvinyl alcohol), PEO (polyethylene oxide), PLA (polylactic acid), PGA (polyglycolic acid), PLA-PGA and the like.

In addition to the above-listed polymer materials, an electrospinnable synthetic polymer or natural polymer may also be used, and any polymer material may be used in the present invention, as long as it does not show an abnormal response to blood.

The solvent that is used in the present invention serves to dissolve the adsorbent material and the polymer material to a concentration suitable for electrospinning so as to have a specific viscosity. Specifically, the solvent may be any one or a mixture of two or more selected from among DMAc (N,N-dimethyl acetamide), DMF (N,N-dimethylformamide), NMP (N-methyl-2-pyrrolidinone), DMSO (dimethyl sulfoxide), THF (tetrahydrofuran), EC (ethylene carbonate), DEC (diethyl carbonate), DMC (dimethyl carbonate), EMC (ethyl methyl carbonate), PC (propylene carbonate), water, acetic acid, formic acid, chloroform, dichloromethane, and acetone. Because the cytokine adsorption sheet is manufactured by an electrospinning method, the thickness thereof is determined according to the amount of spinning solution spun. Thus, there is an advantage in that the thickness of the cytokine adsorption sheet is easily controlled to a desired thickness. In other words, because the thickness of the nanofiber web can be controlled depending on the amount of spinning solution spun, the nanofiber web can be formed to have various thicknesses. Particularly, it can be made thin, and thus the manufacture cost of the adsorption sheet can be reduced, and the blood filter comprising the same can be miniaturized.

As described above, the cytokine adsorption sheet according to the embodiment of the present invention can be made thin, and thus it is possible to manufacture a blood filter that has a small size and, at the same time, has excellent adsorption capacity.

In addition, because the cytokine adsorption sheet comprises the nanofiber web 10 formed by electrospinning, which consists of the stacked nanofibers 12, it can have a large specific surface area, and thus the area for contact with blood can be increased so that the capacity to adsorb cytokines can be increased.

A cytokine adsorption sheet according to another embodiment of the present invention comprises: a nanofiber web prepared by electrospinning a spinning solution prepared by mixing an adsorbent material capable of cytokines with an electrospinnable polymer material, the nanofiber web having a nanofiber diameter of less than 1 μm and a plurality of pores; and a base sheet laminated onto one or both surfaces of the nanofiber web to improve the handing and physical properties of the nanofiber web.

Herein, the nanofiber web 10 has the same configuration as that of the above-described nanofiber web, and the base sheet may be made of any material that has a plurality of pores permeable to blood and that can improve the handling and physical properties of the adsorption sheet. For example, the base sheet may be made of any one or more selected from the group consisting of a nonwoven fabric, a woven fabric, a polymer or metal foam material, paper, and a metal or plastic mesh material.

The nanofiber web and the base sheet may be laminated with each other by various methods, including hot pressing, calendering, laminating hot-melt bonding and ultrasonic bonding. In addition, any method may also be used, as long as the resulting laminate shows no side effects when it comes into contact with blood.

In addition to such lamination methods, a method of laminating the nanofiber web directly on the surface of the base sheet by electrospinning may also be used.

The cytokine adsorption sheet obtained by laminating the nanofiber web with the base sheet is sterilized. For sterilization of the cytokine adsorption sheet, any method based on the use of ethylene oxide, high-temperature or X-rays may be used, as long as it does not affect the physical properties of the nanofiber web and the adsorbent material capable of adsorbing cytokines.

As described above, the cytokine adsorption sheet may comprise the base sheet laminated on one surface of the nanofiber web in order to improve the handling and physical properties thereof.

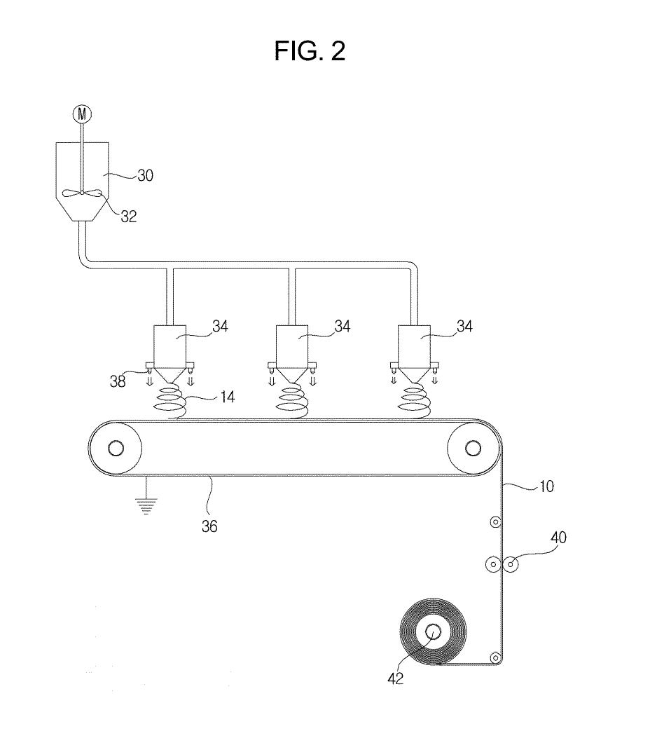

FIG. 2 shows the configuration of an electrospinning apparatus for manufacturing a cytokine adsorption sheet according to an embodiment of the present invention.

As shown in FIG. 2, the electrospinning device according to the present invention comprises: a mixing tank 30 for storing a spinning solution; a plurality of spinning nozzles 34 which are connected with a high-voltage generator and the mixing tank 30 so that nanofibers 14 are spun from the spinning nozzles 34; and a collector 36 on which the nanofibers 14 spun from the spinning nozzles 34 are stacked to form a nanofiber web 10.

The mixing tank 30 is provided with a stirrer 32 configured to uniformly mix an adsorbent material capable of cytokines with an electrospinnable polymer material in a solvent and to maintain the polymer material at a certain viscosity.

A high-voltage electrostatic force is applied between the collector 36 and the spinning nozzles 34, and the nanofibers 14 are spun from the spinning nozzles 34 to form the nanofiber web 10 on the collector 36.

The voltage that is used in the spinning is in the range of 0.5 kV to 100 kV in which the nanofibers can be spun, and the collector 36 may be grounded or negatively charged.

The collector 36 is preferably made of an electrically conductive metal, release paper, a nonwoven fabric or the like. To the collector 36, a suction collector may be attached to facilitate the cohesion of the fibers during spinning. Also, the distance between the spinning nozzle 34 and the collector 36 may be 5-50 cm.

During spinning, the nanofibers are preferably spun at a rate of 0.01-5 cc/min per hole using a metering pump, and the spinning is preferably performed at a relative humidity of 10-90% in a mixing tank whose temperature and humidity are controllable.

In addition, each of the spinning nozzles 34 is provided with an air sprayer 38 configured to spray air to the fibers 14, spun through the spinning nozzles 34, to guide the fibers 14 toward the collector 36 so as to be stacked thereon.

Downstream of the collector 36, pressing rollers 40 are provided which are configured to press the nanofiber web 10, prepared by the electrospinning process, to a predetermined thickness. In addition, provided is a nanofiber web roll 42 around which the nanofiber web 10 pressed through the pressing rollers 40 is wound.

A method of manufacturing the cytokine adsorption sheet using the electrospinning apparatus configured as described above will now be described.

First, a spinning solution is prepared. Specifically, an adsorbent material capable of adsorbing cytokines and an electrospinnable polymer material are dissolved in a suitable solvent to a spinnable concentration to thereby prepare a spinning solution.

The concentration of the absorbent material and the polymer material in the spinning solution is a concentration at which they can maintain a fiber shape during spinning. Preferably, the content of the adsorbent material and the polymer material is 5-90 wt % based on the total weight of the spinning solution.

Herein, if the content is less than 5 wt %, drops rather than nanofibers will be formed during electrospinning due to the low concentration of the polymer material, and thus nanofibers cannot be formed in many cases. If the content is more than 90 wt %, electrospinning itself will be difficult to perform, because the content of the polymer material is too high.

For this reason, it is required to prepare the spinning solution in a suitable concentration range in which nanofibers can be formed, depending on the kind of polymer used. If a mixture of two or more polymers is to be spun, the polymers should be compatible with the solvent, and spinning should be performed under conditions in which no phase separation occurs. In addition, the spinning solution is preferably prepared using a single solvent or a mixture of two or more solvents while taking into consideration the volatilization of the solvent.

When a high-voltage electrostatic force is applied between the collector 36 and the spinning nozzles 34, the nanofibers 18 formed from the spinning solution are spun from the spinning nozzles 34 onto the collector 36. Then, the nanofibers 18 are stacked on the surface of the collector to form the nanofiber web 10.

Herein, the suction collector disposed on the collector facilitates the cohesion of the nanofibers 18 during spinning, and the air sprayer 38 disposed around the spinning nozzles 34 sprays air to the nanofibers so that the nanofibers 18 can be collected and stacked on the surface of the collector 36 without scattering.

The nanofiber web 10 formed as described above is pressed to a predetermined thickness through the pressing rollers 40, and then wound around the nanofiber web roll 42.

In order to improve the handling or physical properties of the cytokine adsorption sheet, a base sheet is lamination onto one surface of the nanofiber web formed as described above.

Herein, the lamination between the nanofiber web and the base sheet is preferably performed in a temperature range in which the adsorbent material capable of adsorbing cytokines is not modified or dissolved.

Particularly, the lamination between the nanofiber web and the base sheet can be performed using methods such as hot pressing, hot-plate calendering, laminating, hot-melt bonding, ultrasonic bonding and the like. When such methods are used, the structure of the nanofibers can be maintained. For example, when glue is used for lamination, it may be a biocompatible glue that is not dissolved upon contact with blood. Among the above methods, any method may be used.

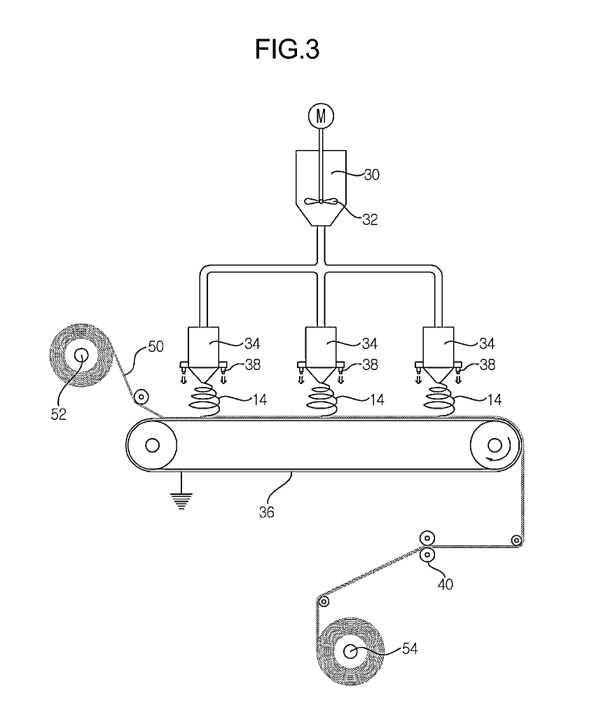

FIG. 3 shows the configuration of an electrospinning apparatus according to another embodiment of the present invention.

An electrospinning apparatus according to another embodiment of the present invention comprises: a mixing tank for storing a spinning solution; a plurality of spinning nozzles 34 which are connected with a high-voltage generator and the mixing tank 30 so that nanofibers 14 are spun from the spinning nozzles 34; a collector 36 on which the nanofibers 14 spun from the spinning nozzles 34 are stacked to form a nanofiber web 10; and a base sheet roll 52 disposed upstream of the collector 36 so as to feed a base sheet 50 to the collector 36.

Downstream of the collector 36, pressing rollers 40 are provided which are configured to press the nanofiber web 10, prepared by the electrospinning process, to a predetermined thickness. In addition, provided is a sheet roll 42 around which a cytokine adsorption sheet composed of a laminate of the base sheet 50 and the nanofiber web 10 is wound.

In addition, if the base sheet 50 are to be laminated on both surfaces of the nanofiber web 10, one additional base sheet roll for feeding the base sheet is further provided downstream of the collector 36.

A method for manufacturing the cytokine adsorption sheet according to this embodiment is as follows.

First, the base sheet 50 wound around the base sheet roll 52 is fed to the collector 36.

When a high-voltage electrostatic force is applied between the collector 36 and the spinning nozzles 34, the nanofibers 14 made from the spinning solution are spun from the spinning nozzles 34 onto the surface of the base sheet 50. Then, the nanofibers 14 are stacked on the surface of the base sheet 50 to form the nanofiber web 10.

Next, an adsorption sheet composed of a laminate of the nanofiber web 10 and the base sheet 50 is pressed to a predetermined thickness through the pressing rollers 40, and then wound around the sheet roll 42.

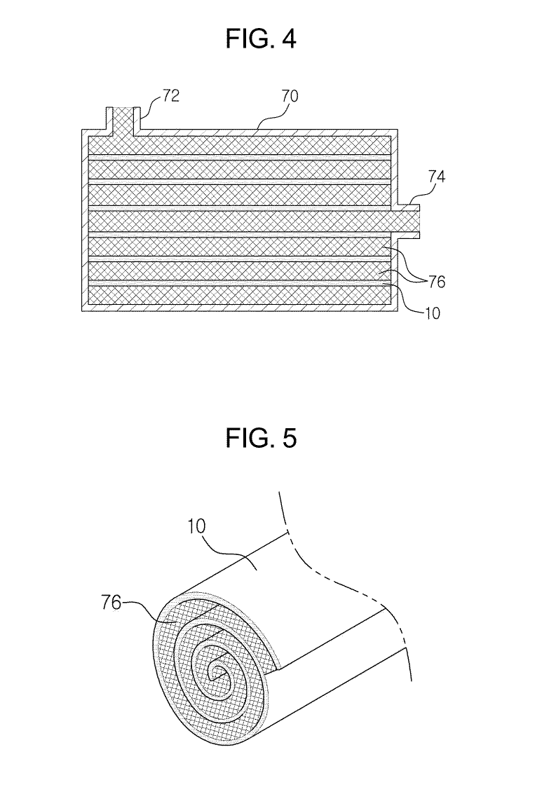

FIG. 4 is a cross-sectional view of a blood filter according to the present invention, and FIG. 5 is a partial perspective view of a cytokine adsorption sheet that is provided in the blood filter of the present invention.

The blood filter of the present invention is formed in a cylindrical shape, and comprises a housing 70 having a blood inlet 72 and a blood outlet 74, and a nanofiber web 10 that is a cytokine adsorption sheet wound around itself at a predetermined interval and is disposed in the housing 70.

In addition, the nanofiber web 10 is rolled around itself at a predetermined interval so as to have a passage through which blood can pass, and a spacer 76 is disposed in the passage. Herein, the spacer 76 may be made of any material such as a nonwoven fabric, which has pores permeable to blood and can maintain the width of the passage.

In addition to this structure, any structure may be applied to the blood filter, as long as it enables blood to come into sufficient contact with the surface of the nanofiber web.

Hereinafter, the present invention will be described by examples.

### Example 1

PMMA (polymethyl methacrylate) that is an electrospinnable polymer material, and PEI (polyethyleneimine) that is a cytokine-adsorbing material, were mixed at a ratio of 80 wt %:20 wt % (PMMA: PEI). The mixture was dissolved in the solvent DMAc in an amount of 20 wt % to prepare a spinning solution. The spinning solution was transferred into a mixing tank, and electrospun under the following conditions to manufacture a nanofiber web: voltage applied: 50 kV, the distance between the spinning nozzles and the collector: 30 cm, discharge rate: 0.05 cc/min per hole, temperature: 30° C., and relative humidity. 60%.

The nanofiber web manufactured as described above was hot-pressed at a temperature of 150 t and a pressure of 5 Kgf/cm² to manufacture a cytokine adsorption sheet.

### Example 2

A cytokine adsorption sheet was manufactured in the same manner as described in Example 1, except that PMMA and PEI were mixed at a ratio of 50 wt %:50 wt %.

FIG. 1 is a scanning electron microscope photograph of the nanofiber web obtained in Example 2. As can be seen therein, the nanofibers had an average diameter of 500 nm and a diameter distribution of 100-700 nm.

### Example 3

A cytokine adsorption sheet was manufactured in the same manner as described in Example 1, except that PMMA was used as the polymer material and a mixture of PS-DVB (polystyrene-divinylbenzene) and PEI was used as the cytokine-adsorbing material, and PMMA/PEI/PS-DVB were used at a ratio of 45/45/10 wt %.

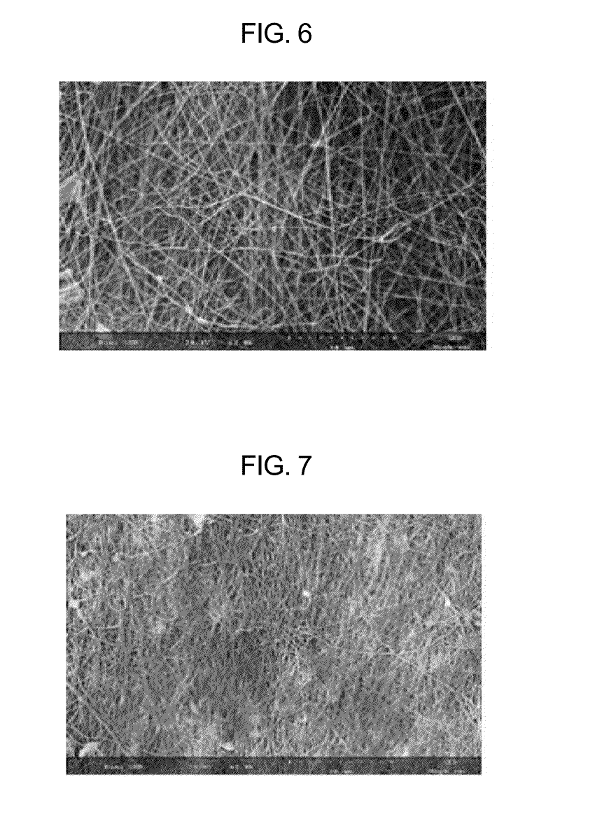

FIG. 6 is a scanning electron microscope photograph of the nanofiber web obtained in Example 3. As can be seen in FIG. 6, the nanofibers had an average diameter of 500 nm and a diameter distribution of 100-700 nm.

### Example 4

A cytokine adsorption sheet was manufactured in the same manner as described in Example 1, except that PAN was used as the polymer material, and PEI was used as the cytokine-adsorbing material, and PAN and PEI were used at a ratio of PAN/PEI=40/60 wt %.

FIG. 7 is a scanning electron microscope photograph of the nanofiber web obtained in Example 3. As can be seen in FIG. 7, the nanofibers in the nanofiber web were uniformly formed and had an average diameter of about 400 nm.

Experiment on Cytokine Adsorption

In order to examine the therapeutic effect of the cytokine adsorption sheet of the present invention, TNF-α, IL-1β, IL-6 and IL-8 that are recombinant human cytokines were added to fresh frozen human plasma, and an in vitro adsorption experiment was performed according to the method described in Biomaterials ((2006) 27:5755).

LPS (lipopolysaccharide) was injected into an animal (dog) (30 Kg) for 10 minutes to induce sepsis, and after 2 hours, and the blood was collected and centrifuged to separate plasma, which was then freeze-stored.

The cytokine spiked plasma was added to fresh frozen human plasma, and each adsorbent pre-wetted with PBS (phosphate buffer solution) was added to the plasma solution, which was then stirred in a shaking water bath at 37° C. and 60 rpm. The initial solution was used as a control, and 1 cc of a sample was collected from the solution after 1 hour and 2 hours. The collected samples were quantitatively and qualitatively analyzed by ELISA (enzyme-linked immunosorbent assay) in order to compare the adsorption capacity between the adsorbents.

Experimental Result 1

2 cc of a solution of cytokine spiked plasma was added to 0.3 g of the adsorbent sheet, and the adsorption of cytokines by the adsorption sheet was measured over time. The results are shown in Tables 1 and 2 below.

TABLE 1
Adsorption of TNF-α according to adsorption time

| | | Change in content of TNF-α with adsorption time | | | | |
|---|---|---|---|---|---|---|
| | | 0 hr | 1 hr | | 2 hrs | |
| | | Content | Content | Removal | Content | Removal rate |
| | | (Pg/ml) | (Pg/ml) | rate (%) | (Pg/ml) | (%) |
| Adsorption | Example 1 | 1,646.24 | 1,562.50 | 5.09% | 1,472.95 | 10.53% |
| sheet | Example 2 | 1,646.24 | 1,408.23 | 14.46% | 1,360.15 | 17.38% |
| | Example 4 | 1,646.24 | 1,594.20 | 3.16% | 1,538.99 | 6.51% |
| | Control | 1,646.24 | 1,551.41 | 5.76% | 1,606.88 | 2.39% |

TABLE 2
Adsorption of IL-6 according to adsorption time

| | | Change in content of IL-6 with adsorption time | | | | |
|---|---|---|---|---|---|---|
| | | 0 hr | 1 hr | | 2 hrs | |
| | | Content | Content | Removal | Content | Removal rate |
| | | (Pg/ml) | (Pg/ml) | rate (%) | (Pg/ml) | (%) |
| Adsorption | Example 1 | 77,305.38 | 27,988.02 | 63.80% | 15,985.44 | 79.32% |
| sheet | Example 2 | 77,305.38 | 17,755.68 | 77.03% | 6,117.00 | 92.09% |
| | Example 4 | 77,305.38 | 78,322.86 | −1.32% | 74,137.20 | 4.10% |
| | Control | 77,305.38 | 76,519.56 | 1.02% | 81,193.20 | −5.03% |

As can be seen in Table 1 above, the removal rate of cytokines increased as the content of the adsorbent material PEI increased. However, it appears that the adsorption of TNF-α by the adsorption sheet of the Examples of the present invention up to 1 hour did not significantly differ from the control.

However, it can be seen that the removal rate of IL-6 by the adsorption sheet of the present invention was significantly higher than the control. In addition, it can be seen that the use of PAN as the polymer material in Example 4 showed insignificant improvement in the adsorption of cytokines.

Experimental Result 2

2 cc of a solution containing cytokine spiked plasma was added to 0.3 g and 0.6 g of the adsorption sheet obtained in Example 2, and the adsorption of cytokines by the adsorption sheet was measured over time. The results are shown in Tables 3 and 4 below.

TABLE 3
Adsorption of TNF-α according to weight of adsorption sheet

| | | Change in content of TNF-α with adsorption time | | | | |
|---|---|---|---|---|---|---|
| | | 0 hr | 1 hr | | 2 hrs | |
| | | Content | Content | Removal | Content | Removal rate |
| | | (Pg/ml) | (Pg/ml) | rate (%) | (Pg/ml) | (%) |
| Adsorption | Example 2 | 6,236.00 | 5,512.00 | 11.61% | 5,892.00 | 5.52% |
| sheet | (0.3 g) | | | | | |
| | Example 2 | 6,236.00 | 5,104.00 | 18.15% | 5,728.00 | 8.15% |
| | (0.6 g) | | | | | |
| | Control | 6,236.00 | 5,688.00 | 8.79% | 6,128.00 | 1.73% |

TABLE 4
Adsorption of IL-6 according to weight of adsorption sheet

| | | Change in content of IL-6 with adsorption time | | | | |
|---|---|---|---|---|---|---|
| | | 0 hr | 1 hr | | 2 hrs | |
| | | Content | Content | Removal | Content | Removal |
| | | (Pg/ml) | (Pg/ml) | rate (%) | (Pg/ml) | rate (%) |
| Adsorption | Example 2 | 78,841.20 | 25,060.80 | 68.21% | 9,329.30 | 88.17% |
| sheet | sample (0.3 g) | | | | | |
| | Example 2 | 78,841.20 | 13,993.80 | 82.25% | 4,299.00 | 94.55% |
| | sample (0.6 g) | | | | | |
| | Control | 78,841.20 | 76,554.60 | 2.90% | 71,341.20 | 9.51% |

As can be seen in Tables 3 and 4, as the content of the adsorption material in the adsorption sheet of the present invention increased, the removal rate of cytokines also increased. When the adsorption of cytokines by the sample of Example 2 (0.3 g) at an adsorption time of 1 hour is taken as 100%, it can be seen that the removal rates of TNF-α and IL-6 by the sample (0.6 g) are 156.35% and 120.58%, respectively.

Experimental Result 3

10 cc of a solution of cytokine spiked plasma was added to 0.2 g of the adsorption sheet, and the adsorption of cytokines by the adsorption sheet was measured over time. The results are shown in Tables 5 to 8 below.

TABLE 5
Adsorption of TNF-α according to adsorption time

| | | Change in content of TNF-α with adsorption time | | | | |
|---|---|---|---|---|---|---|
| | | 0 hr | 1 hr | | 2 hr | |
| | | Content | Content | Removal rate | Content | Removal rate |
| | | (Pg/ml) | (Pg/ml) | (%) | (Pg/ml) | (%) |
| Adsorption sheet | Example 2 | 136.00 | 88.00 | 35.29% | 82.30 | 39.49% |
| | Example 3 | 136.00 | 91.10 | 33.01% | 88.60 | 34.85% |
| | Control | 136.00 | 110.00 | 19.12% | 105.20 | 22.65% |

TABLE 6
Adsorption of IL-6 according to adsorption time

| | | Change in content of IL-6 with adsorption time | | | | |
|---|---|---|---|---|---|---|
| | | 0 hr | 1 hr | | 2 hr | |
| | | Content | Content | Removal | Content | Removal rate |
| | | (Pg/ml) | (Pg/ml) | rate (%) | (Pg/ml) | (%) |
| Adsorption | Example 2 | 3,516.90 | 1,627.10 | 53.73% | 1,252.00 | 64.40% |
| sheet | Example 3 | 3,516.90 | 2,006.20 | 42.96% | 1,688.80 | 51.98% |
| | Control | 3,516.90 | 3,533.40 | −0.47% | 3,442.90 | 2.10% |

TABLE 7
Adsorption of IL-1β according to adsorption time

| | | Change in content of IL-1β with adsorption time | | | | |
|---|---|---|---|---|---|---|
| | | 0 hr | 1 hr | | 2 hr | |
| | | Content | Content | Removal rate | Content | Removal rate |
| | | (Pg/ml) | (Pg/ml) | (%) | (Pg/ml) | (%) |
| Adsorption sheet | Example 2 | 479.50 | 362.80 | 24.34% | 337.30 | 29.66% |
| | Example 3 | 479.50 | 368.20 | 23.21% | 354.80 | 26.01% |
| | Control | 479.50 | 457.60 | 4.57% | 442.40 | 7.74% |

TABLE 8
Adsorption of IL-8 according to adsorption time

| | | Change in content of IL-8 with adsorption time | | | | |
|---|---|---|---|---|---|---|
| | | 0 hr | 1 hr | | 2 hr | |
| | | Content | Content | Removal rate | Content | Removal rate |
| | | (Pg/ml) | (Pg/ml) | (%) | (Pg/ml) | (%) |
| Adsorption sheet | Example 2 | 538.30 | 270.80 | 49.69% | 245.70 | 54.93% |
| | Example 3 | 538.30 | 351.70 | 34.66% | 327.00 | 39.25% |
| | Control | 538.30 | 531.30 | 1.30% | 605.00 | 6.00% |

Generally, the contents of cytokines show a tendency to slightly increase or decrease even in a natural state. This tendency appeared in the controls in Tables 5 and 6, but it can be seen that the removal rates of cytokines in the controls were very low compared to those in the Examples of the present invention. Particularly, from the results in Tables 6 to 8, it was shown that, unlike the control showing a cytokine removal rate of 8% or less after 2 hours, the Examples of the present invention showed a cytokine removal rate as high as 60% or more.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention is applicable to a blood filter comprising a cytokine adsorption sheet, and thus can be effectively applied for the treatment of sepsis.

1. A cytokine adsorption sheet comprising a nanofiber web formed by electrospinning a spinning solution prepared by mixing an adsorbent material capable of cytokines with an electrospinnable polymer material.

2. The cytokine adsorption sheet of claim 1, wherein the nanofiber web is formed to have a plurality of pores by electrospinning the spinning solution to make nanofibers and stacking the nanofibers.

3. The cytokine adsorption sheet of claim 1, wherein the nanofiber web has a nanofiber diameter of 100-800 nm and an average pore size of 0.1-10 μm.

4. The cytokine adsorption sheet of claim 1, wherein the nanofiber web has a thickness of 1-150 μm.

5. The cytokine adsorption sheet of claim 4, wherein the nanofiber web has a thickness of 15-20 μm.

6. The cytokine adsorption sheet of claim 1, wherein the adsorbent material is any one or a mixture of two or more selected from among polymyxin-B, PEI, PVP, and PS-DVB (polystyrene-divinylbenzene).

7. The cytokine adsorption sheet of claim 1, wherein the polymer material is any one or a mixture of two or more selected from among PVDF (polyvinylidene fluoride), PMMA (polymethylmethacrylate), PAN (polyacrylonitrile), PU (polyurethane), PES (polyethersulfone), PAA (polyamic acid), PVA (polyvinyl alcohol), PEO (polyethylene oxide), PLA (polylactic acid), PGA (polyglycolic acid), and PLA-PGA-based polymers.

8. The cytokine adsorption sheet of claim 1, further comprising a base sheet laminated on one surface of the nanofiber web.

9. The cytokine adsorption sheet of claim 8, wherein the base sheet has a plurality of pores permeable to blood, and is made of any one of any one selected from among a nonwoven fabric, woven fabric, a polymer foam material, a metal foam material, paper, a metal mesh material, and a plastic mesh material.

10. A blood filter including a cytokine adsorption sheet comprising a nanofiber web formed by electrospinning a spinning solution prepared by mixing an adsorbent material capable of cytokines with an electrospinnable polymer material.

11. The blood filter of claim 10, wherein the cytokine adsorption sheet is rolled around itself at a predetermined interval so as to have a passage through which blood passes, and a spacer is disposed in the passage.

12. A method for manufacturing a cytokine adsorption sheet, the method comprising the steps of:
mixing an adsorbent material capable of adsorbing cytokines with an electrospinnable polymer material in a solvent to prepare a spinning solution; and
electrospinning the spinning solution to form a nanofiber web having a plurality of pores.

13. The method of claim 12, wherein a content of the adsorbent material and the polymer material is 5-90 wt % based on the total weight of the spinning solution.

14. The method of claim 12, further comprising a step of passing the nanofiber web through pressing rolls to press it to a predetermined thickness.

15. The method of claim 13, further comprising a step of laminating a base sheet on one surface of the nanofiber web.

16. The method of claim 15, wherein the base sheet is attached to one surface of the nanofiber web by any one method selected from among hot melting calendering, laminating, hot-melt bonding and bonding.

17. The method of claim 15, further comprising a step of sterilizing the base sheet.

18. A method for manufacturing a cytokine adsorption sheet, the method comprising the steps of:
dissolving an adsorbent material capable of adsorbing cytokines with an electrospinnable polymer material in a solvent to prepare a spinning solution;
preparing a base sheet; and
electrospinning the spinning solution onto the base sheet to form a nanofiber web having a plurality of pores on the base sheet.
